(19) United States
(12) Patent Application Publication
(10) Pub. No.: US 2008/0024024 A1
(43) Pub. Date: Jan. 31, 2008

(54) MOTOR AND METHOD OF MANUFACTURING THEREOF

(75) Inventor: Takehito TAMAOKA, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 11/781,997

(22) Filed: Jul. 24, 2007

(30) Foreign Application Priority Data
Jul. 28, 2006 (JP) 2006-205478

(51) Int. Cl. H02K 5/167; H02K 15/14

(52) U.S. Cl. 310/90; 29/598; 360/98.08; 384/228; 384/297

(57) ABSTRACT

A primer is applied to a radially outer surface of a sleeve unit, and an adhesive is applied to an inner circumferential surface of a base defining a through hole in the base prior to the sleeve unit is inserted into the through hole. The sleeve unit includes a flange portion extending over entire circumference of the sleeve unit. The flange portion is used as a mark for applying the primer to the radially outer surface of the sleeve unit, and prevents the primer from flowing along the radially outer surface and entering into a bearing mechanism of the motor. Through the configuration, a base and a sleeve unit are firmly fixed to each other without degrading a bearing characteristic.

### BACKGROUND OF THE INVENTION

1. Field of the invention

The present invention generally relates to an electrically powered motor and a method of manufacturing thereof.

2. Background of related art

A storage disk drive device such as a hard disk drive conventionally includes a spindle motor for rotationally driving the data storage disk(s). (Such spindle motors will be simply referred to as “motors” hereinafter). One motor bearing mechanism that has been adopted in recent years is the hydrodynamic-pressure employing bearing mechanism.

Conventionally, a component of the bearing mechanism such as a bearing sleeve and a sleeve housing is made of metallic material. In recent days, the sleeve housing is increasingly made of resin. The Japanese laid open patent publication No. 2005-282770 discloses a technique of reinforcing an adhesive characteristics of an adhesive which fixes the sleeve housing made of resin and a member supporting the sleeve housing to each other. In the publication, at least one of the sleeve housing and the member supporting the sleeve housing is a resin-molded product, and the surface finishing (e.g., alkaline etching) is performed to a portion of the surface of the resin-molded product at which the sleeve housing and the member supporting the sleeve housing are fixed to each other.

The Japanese laid open patent publication No. H09-9568 discloses a sleeve having a flange portion which comes in contact with a bracket in FIG. 2.

Conventionally, when a piece of member made of resin and the other piece of member made of metallic material are fixed to each other by an adhesive, a primer is applied to the surface of the resin sleeve housing to activate the surface activity of resin material and reinforce the adhesive characteristics. When the sleeve housing and the base are fixed to each other with the adhesive, it is difficult to apply the adequate amount of the primer to sleeve housing having a small size. When excessive amount of primer is applied to the sleeve housing, the primer flows to an axially end portion (i.e., a rotor-unit side end) of the sleeve housing and may enter into the bearing mechanism, degrading the performance of the bearing mechanism. When the primer is applied to the sleeve housing while a lower side of the sleeve housing is directed to an upper direction in a direction of gravity, the primer easily flows to the end portion of the sleeve housing and enters into the bearing mechanism. Furthermore, the primer flowing to the end portion of the sleeve housing may cause the outgas, resulting in read/write errors of the data storage disk driving device.

When the amount of the primer applied to the sleeve housing is less than the adequate amount, the sleeve housing and the base are not fixed to each other with enough joint strength. As stated above, it is difficult to apply an adequate amount of primer to a smooth circumferential surface of the sleeve housing.

### SUMMARY OF THE INVENTION

In order to overcome the problems described above, preferred embodiments of the present invention provide a motor in which a base and a sleeve unit are firmly fixed to each other without degrading a bearing characteristic. The preferred embodiments of the present invention also provide a method of manufacturing the motor in which a primer is adequately applied to a radially outer surface of a sleeve unit made of resin, enabling to firmly fix the sleeve unit and the base to each other without degrading a performance of a bearing mechanism of the motor.

In the method of manufacturing the motor according to the preferred embodiments of the present invention, the motor includes a shaft attached to a rotor unit, a sleeve unit having a substantially cylindrical shape whose one end is opened and the other end is closed, in which the shaft is inserted from one end toward the other end, and a base having a through hole defined by an inner circumferential surface, to which the sleeve unit is inserted.

The method of manufacturing the motor according to the preferred embodiments of the present invention includes a step of applying a primer, a step of applying an adhesive, and a step of inserting the sleeve unit into the through hole of the base.

In the step of applying the primer, the primer is applied to a portion of a radially outer surface of the sleeve unit. The sleeve includes an antisagging feature arranged over an entire circumference of the sleeve. The portion of the radially outer surface is the other end side from the antisagging feature.

In the step of applying the adhesive, the adhesive is applied to at least one of the portion of the radially outer surface of the sleeve unit and a portion of the inner circumferential surface of the base.

In the step of inserting the sleeve unit into the through hole of the base, the other end side of the sleeve unit is inserted into the through hole defined by the inner circumferential surface of the base. In the process, the portion of the inner circumferential surface of the base to which the adhesive is applied radially comes to radially face the portion of the radially outer surface of the sleeve unit.

In one aspect of the preferred embodiments of the present invention, in the step of applying the primer, the sleeve unit is supported in a manner that the other end of the sleeve unit is directed upward in a direction of gravity, and in the step of inserting the sleeve unit into the through hole of the base, the sleeve unit is inserted into the through hole of the base from the other end side of the sleeve unit.

In another aspect of the preferred embodiments of the present invention, the antisagging feature is a flange portion or a concave portion arranged to the radially outer surface of the sleeve unit.

Through the configuration mentioned above, the sleeve unit and the base are firmly fixed to each other with the primer and the adhesive while preventing the primer from flowing along the radially outer surface of the sleeve unit and entering into a bearing mechanism which degrades the bearing mechanism.

Preferred embodiments of the present invention also provide an electrically powered motor. The motor includes a sleeve unit, a rotor unit, a base, and a driving mechanism which generates rotation force rotating the rotor unit relative to the base.

The sleeve unit has a substantially cylindrical shape whose one end is opened and the other end is closed. A radially outer surface of the sleeve unit is made of resin and includes antisagging feature going around an entire circumference of the sleeve unit. The rotor unit includes a shaft attached thereto. The shaft is inserted into the sleeve unit from one end to the other end and rotatably supported by the sleeve unit. The base includes a through hole defined by an inner circumferential surface to which the radially outer surface is attached by an adhesive arranged therebetween.

Other features, elements, characteristics and advantages of the present invention will become more apparent from the following detailed description of preferred embodiments of the present invention with reference to the attached drawings.

### BRIEF DESCRIPTION OF DRAWINGS

FIG. 1 is a view illustrating a cross section of a motor according to a first preferred embodiment of the present invention.

FIG. 2 is a view illustrating a cross section of a bearing mechanism of the motor.

FIG. 3 is a chart setting forth process flow in manufacturing of the motor.

FIG. 4 is a view illustrating a motor assembly during the manufacturing process of the motor.

FIG. 5 is a view illustrating a cross section of a motor according to a second preferred embodiment of the present invention.

FIG. 6 is a view illustrating a cross section of a bearing mechanism of a motor according to a third preferred embodiment of the present invention.

FIG. 7 is a view illustrating a cross section of a bearing mechanism of a motor according to a fourth preferred embodiment of the present invention.

FIG. 8 is a view illustrating a cross section of a sleeve housing according to a fifth preferred embodiment of the present invention.

FIG. 9 is a view illustrating a cross section of a sleeve housing according to a sixth preferred embodiment of the present invention.

### DETAIL DESCRIPTION OF PREFERRED EMBODIMENTS

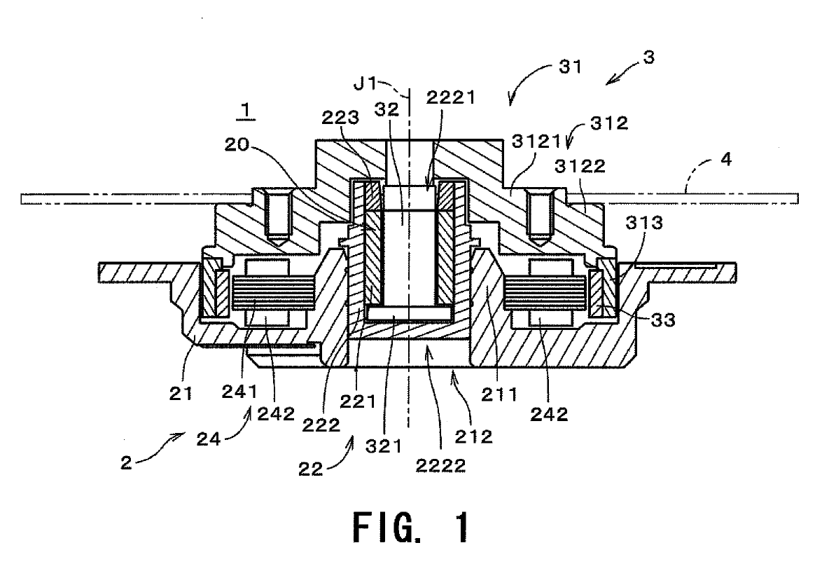

FIG. 1 is a cross sectional view illustrating a configuration of an electrically powered motor 1 according to a first preferred embodiment of the present invention. In preferred embodiments of the present invention, the motor 1 is used for spinning a data storage disk 4 in a hard disk drive. The data storage disk 4 is illustrated by chain double-dashed lines in FIG. 1. As illustrated in FIG. 1, the motor 1 is an outer rotor motor, and includes a stator unit 2 which is a stationary assembly and a rotor unit 3 which is a rotatable assembly. The rotor unit 3 is supported via a bearing mechanism 20 employing hydrodynamic pressure by the agency of lubricant oil such that the rotor unit 3 is rotatable relative to the stator unit 2 about a center axis J1. It should be understood that in the preferred embodiments of the present invention, for the sake of convenience the upward and downward orientations along the center axis J1 in the drawings are described as upper/lower and/or top/bottom direction of the motor 1, but that is not intended to limit the orientation of the bearing, motor, and disk drive of the invention in an actually installed situation.

The stator unit 2 includes a base bracket 21 (a base portion of the motor 1) which retains the different parts of the stator unit 2, a sleeve unit 22 having a cylindrical shape whose lower end is closed and rotatably supporting the rotor unit 3, and an armature 24 which is attached to the base bracket 21 along an outer circumferential surface of the sleeve unit 22. The base bracket 21 includes a holder portion 211 which has a substantially cylindrical shape centered on the center axis J1. The holder portion 211 includes an inner circumferential surface defining a through hole 212 in which the sleeve unit 22 is inserted. The sleeve unit 22 is fixedly arranged at radially inside of the holder portion 211 with an adhesive.

The sleeve unit 22 includes a sleeve 221 having a substantially cylindrical shape whose lower end is closed and in which a shaft 32 is inserted, a sleeve housing 222 having a substantially cylindrical shape whose lower end is closed and in which the sleeve 221 is accommodated, and a sealing cap 223 accommodated in the sleeve housing 222 and arranged axially upper side of the sleeve 221. In the preferred embodiment of the present invention, the shaft 32 is inserted into the sleeve from an opening 2221 toward a sleeve housing base 2222. The sleeve housing 222 is preferably made of resin. The sleeve 221 is preferably made of a porous material (e.g., a porous sintered material), and the sleeve housing 222 holds the lubricant oil with which the sleeve 221 is impregnated. The armature 24 includes a core 241 made by laminating a plurality of silicon steel plates and a plurality of coils 242 defined by wires wound around a plurality of teeth provided on the core 241.

The rotor unit 3 includes a rotor hub 31 which retains the different parts of the rotor unit 3 and on which the data storage disk 4 is arranged, the shaft 32 axially downwardly extending from the rotor hub 31 with centering on the center axis J1, and a rotor magnet 33 which encircles the center axis J1 and is attached to the rotor hub 31. The rotor magnet 33 is a circular multipolar magnet and generates rotation force (torque) centering on the center axis J1 between itself and the armature 24. In other words, the rotor unit 3 rotates relative to the base bracket 21 by an interaction between the armature 24 and the rotor magnet 32 constituting a driving mechanism of the motor 1.

The rotor hub 31 includes a hub body 312 having a discoid shape radially outwardly extending, with respect to the center axis J1, from the upper end portion of the shaft 32 and a substantially cylindrical yoke 313 downwardly extending along the rim of the hub body 312. The rotor magnet 33 is arranged radially inside of the yoke 313.

The hub body 312 is made of aluminum, aluminum array and the like and includes a convex portion 3121 which is fitted in a circular opening arranged in a center of the data storage disk 4, and a disk placing portion 3122 arranged around the convex portion 3121, having a substantially annular shape centered on the center axis J1, and supporting the data storage disk 4. The yoke 313 is made of ferromagnetic material (e.g., stainless steel) and is arranged below the disk placing portion 3122. The shaft 32 is made of stainless steel, and the upper end portion thereof is interference fitted in a through hole arranged in the convex portion 3121 of the hub body 312. A substantially discoid thrust plate 321 is attached to a lower end portion of the shaft 32.

In the motor 1, micro-gaps are provided: in between a radially inner surface of the sealing cap 223 and a radially outer surface of the shaft 32; in between a radially inner surface of the sleeve 221 and the radially outer surface of the shaft 32; in between a axially lower surface of the sleeve 221 and an axially upper surface of the thrust plate 321; and in between the axially lower surface of the thrust plate 321 and the axially upper surface of the sleeve housing base 2222. Lubricating oil continuously fills the micro-gaps between the shaft 32, the thrust plate 321, sleeve unit 22, the sleeve housing 222 and the sealing cap 23 without interruption, whereby a fully filled bearing mechanism 20 (simply referred to as the bearing mechanism 20) is provided. At a portion of the sealing cap 223 radially facing the shaft 32, the diameter of the radially inner surface of the sealing cap 223 gradually expands along the axially upper direction such that a micro-gap therebetween gradually expands along the axially upper direction. Through the configuration described above, so called “taper-seal section” is defined between the sealing cap 223 and the shaft 32, whereby the gap functions as an oil buffer, preventing outflow of the lubricating oil.

In the axially lower surface of the sleeve 221, grooves (e.g., grooves in spiral form) for developing in the lubricating oil pressure directed toward the center axis J1 when the rotor unit 3 spins are formed, wherein a thrust dynamic-pressure bearing section is defined with means of the axially lower surface of the sleeve 221 and the axially upper surface of the thrust plate 321 opposing thereto. Grooves for developing in the lubricating oil pressure may be formed in the axially lower surface of the thrust plate 222, and the axially lower surface of the thrust plate 222 and the axially upper surface of the sleeve housing base 222 opposing thereto may define a portion of the thrust dynamic-pressure bearing section. Additionally, grooves (e.g., herringbone grooves provided on an axially upper and lower portions of the radially inner surface of the sleeve 221) are provided in the radially inner surface of the sleeve 221 for developing hydrodynamic pressure in the lubricating oil, wherein a radial dynamic-pressure bearing section is defined by the radially inner surface of the sleeve 221 and the radially outer surface of the shaft 32 opposing to each other.

In the motor 1, the fact that the rotor unit 3 is supported in a non-contact manner via the lubricating oil by the bearing mechanism 20 employing the hydrodynamic pressure enables the rotor unit 3 and the data storage disk 4 supported thereon to spin with high precision and low noise.

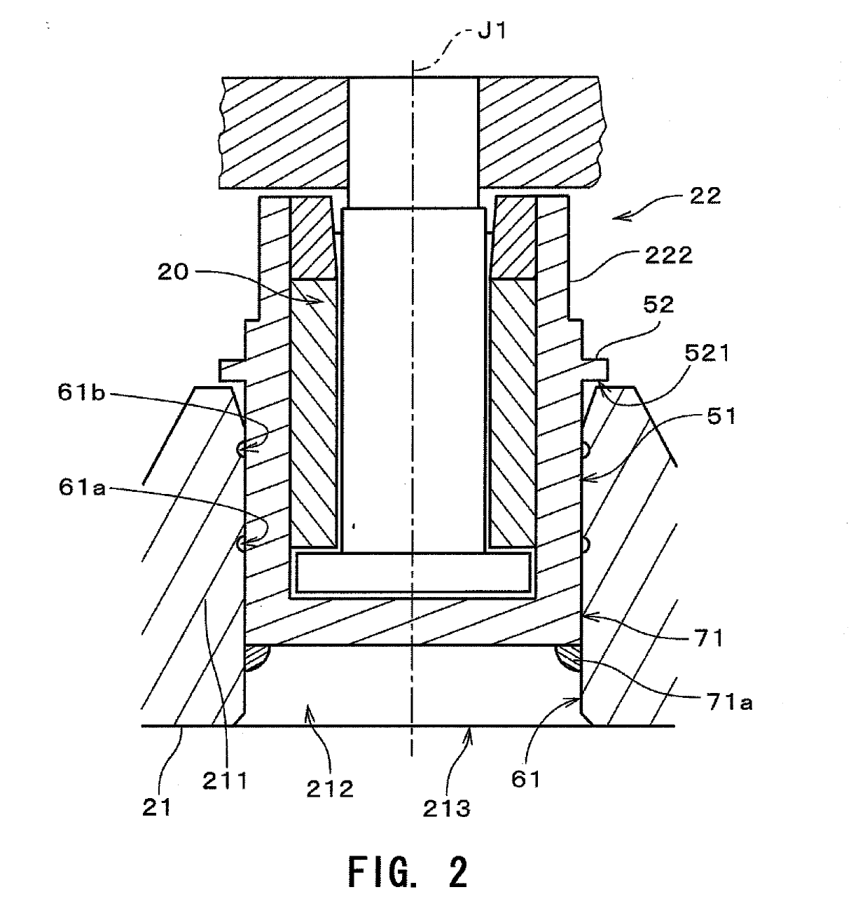

FIG. 2 is a view illustrating a cross section along the center axis J1 of the bearing mechanism 20 of the motor 1. The sleeve unit 22 is loosely fitted in the holder portion 211 having a hollow cylindrical shape, and a radially outer surface of the sleeve unit 22 which is defined by a radially outer surface 51 of the sleeve housing 222 made of resin and a inner circumferential surface 61 of the holder portion 221 are fixed to each other by an adhesive 71 arranged therebetween, whereby the sleeve unit 22 is fixedly arranged radially inside of the holder portion 211 of the base bracket 21.

The sleeve housing 222 includes a flange portion 52 having an annular shape centered on the center axis J1 and radially outwardly extending from the radially outer surface 51. The holder portion 211 includes annular grooves 61a and 61b formed in the inner circumferential surface 61, centered on the center axis J1 and axially spaced from each other.

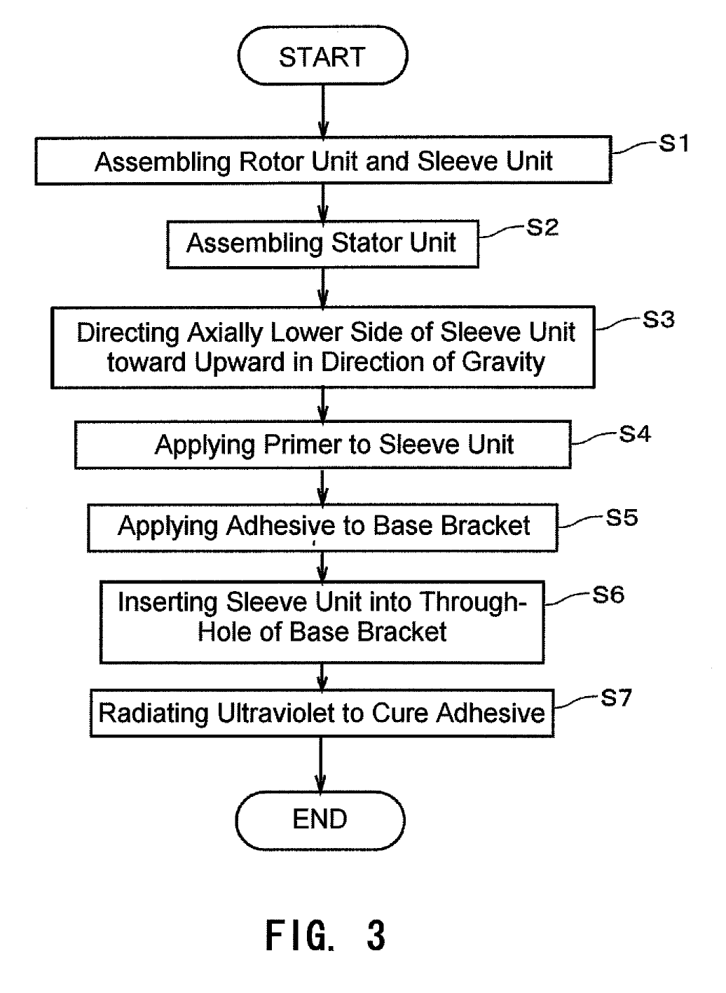

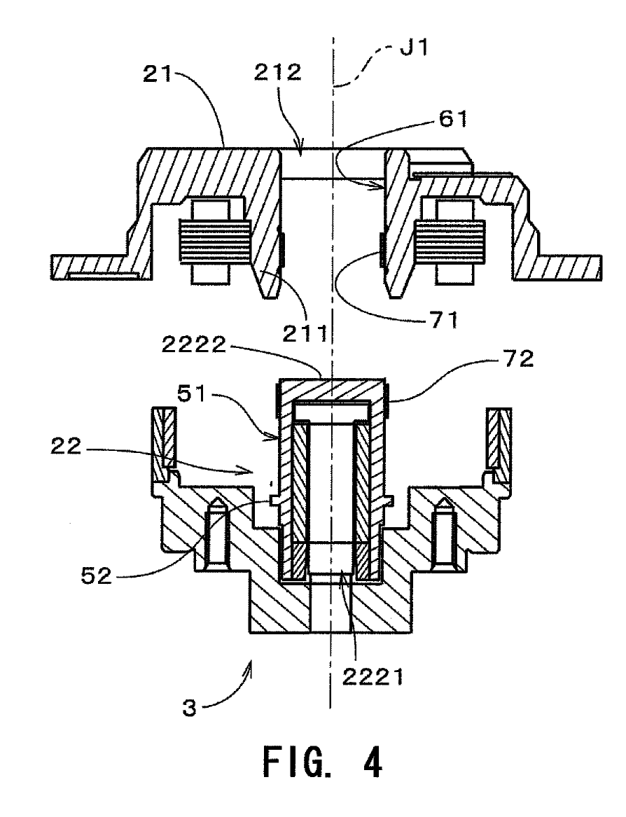

FIG. 3 is a chart setting forth process flow in manufacturing of the motor 1. FIG. 4 is a view illustrating a work in process motor during the manufacturing process of the motor 1. It should be noted that the orientation of the motor 1 illustrated in FIG. 4 is upside down from that of the motor 1 illustrated in FIG. 1.

In a method of manufacturing the motor 1 according to a preferred embodiment of the present invention, firstly, the rotor unit 3 and the sleeve unit 22 are assembled (a step S1), and the stator unit 2 is assembled (a step S2). Then, the rotor unit 3 and the sleeve unit 22 are supported in a manner axially lower sides thereof are directed upward in a direction of gravity (a step S3), and a primer 72 which accelerates hardening of the adhesive and reinforces an adhesive characteristics is applied to the radially outer surface 51 of the sleeve unit 22 (a step S4).

The primer 72 is applied to an area of the radially outer surface 51, arranged axially between the sleeve housing base 2222 and the flange portion 52. The primer 72 applied to the area of the radially outer surface 51 flows axially downwardly along the radially outer surface 51, but the flow of the primer 72 in the axial direction is restricted by the flange portion 52 (i.e., the flange portion 52 is utilized as an antisagging feature of the primer 72). The primer 72 may include metal ion therein. The primer 72 may be applied to a portion of the area of the radially outer surface 51, axially between the sleeve housing base 2222 and the flange portion 52. For example, a plurality of spots to which the primer 72 is applied may be arranged in the area of the radially outer surface 51, axially between the sleeve housing base 2222 and the flange portion 52. In the preferred embodiment of the present invention, one or more of ASEC8250 commercially available from ASEC CO., LTD, and TB1390E, TB1390F, and TB1390K commercially available from ThreeBond are preferably used as the primer 72.

After the primer 72 is applied to the radially outer surface 51 of the sleeve unit 22, the rotor unit 3 and the sleeve unit 22 are heated and then the temperature is maintained at constant.

Then, an aerobic UV cure adhesive (i.e., the adhesive 71) is applied to an area of the inner circumferential surface 61 of the holder portion 211, axially between the annular grooves 61a and 61b illustrated in FIG. 2 (a step S5). In the preferred embodiment of the present invention, one or more of ASEC5851 commercially available from ASEC CO., LTD, TB1350 commercially available from ThreeBond, and AE-750 commercially available from Ajinomoto-Fine-Techno Co., Inc are used as the adhesive 71. With the annular groove 61b arranged in the inner circumferential surface 61 of the holder portion 211, the adhesive 71 does not flow and reach to the axial end of the holder portion 211 along the inner circumferential surface 61 when the rotor unit 3 and the bearing mechanism 20 are supported in a manner illustrated in FIG. 4. Subsequently, as illustrated in FIG. 4, the base bracket 21 is arranged such that the center axis thereof is aligned with the center axis J1, and then, the base bracket 21 is moved toward the rotor unit 3 and the sleeve housing base 2222 directed upward in the direction of gravity is fitted into the holder portion 211.

The sleeve unit 22 is inserted into the through hole 212 of the base bracket 21 until the flange portion 52 is about to come in contact with the holder portion 211. Then the adhesive 71 arranged radially between the sleeve unit 22 and the holder portion 211 of the base bracket 21 is isolated from outside air and thus the adhesive 71 is cured. In the present preferred embodiment of the present invention, the annular grooves 61a and 61b are arranged so as to radially face the area of the radially outer surface 51 of the sleeve housing 222 to which the primer is applied. Due to the configuration, the area of the inner circumferential surface 61 to which the adhesive 71 is applied radially faces the area of the radially outer surface 51 of the sleeve housing 222 while inserting the sleeve unit 22 into the holder portion 211, preferably arranging the adhesive 71 radially between the sleeve unit 22 and the holder portion 211. The adhesive 71a protruding from axially lower end of the radially outer surface 51 is cured by radiating ultraviolet thereto (a step S7). An amount of the adhesive 71 to be applied to the inner circumferential surface 61 of the holder portion 211 is adjusted such that the adhesive 71a protruding from the axially lower end of the radially outer surface 51 of the sleeve housing 222 does not protrude axially downwardly from the lower surface of the base bracket 21.

Thus, as described above, in the preferred embodiment of the present invention, the primer 72 is adequately applied to the predetermined area of the sleeve unit 22 since the flange portion 521 prevent the primer 72 from flowing into the opening 2221 side of the sleeve unit 22. In addition, by using the flange portion 52 as a mark, the primer 72 is adequately applied to the predetermined area of the radially outer surface 51 of the sleeve unit 22. Through the configuration mentioned above, the sleeve unit 22 and the base bracket 21 are firmly fixed to each other with the primer 72 and the adhesive 71 while preventing the primer 72 from degrading the bearing mechanism 20 by flowing along the radially outer surface 51 of the sleeve housing 222 and entering into the bearing mechanism 20. In addition, the flange portion 52 arranged on the radially outer surface 51 of the sleeve housing 222 restricts contaminations caused by outgases from the primer 72 to spread into the axially upper direction in the motor 1. Thus, by adapting the motor 1 according to the preferred embodiment of the present invention to the data storage disk drive, reading/writing errors caused by outgases may be reduced.

When the bearing mechanism employing the fluid dynamic pressure of the lubricating oil is interference fitted into the base bracket, the pressure due to the press-fitting adversely affects the performance of the bearing mechanism. Thus, the bearing mechanism employing fluid dynamic pressure of the lubricating oil is generally loosely fitted and fixed to the base bracket by the adhesive. A technique according to the preferred embodiments of the present invention, providing the flange portion 52 on the radially outer surface 51 of the sleeve housing 222, to which the primer 72 is applied, is preferably adapted to fixing the bearing mechanism 20 employing the fluid dynamic pressure to the base bracket 21.

In the manufacturing method of the motor 1 according to the preferred embodiment of the present invention, the sleeve unit 22 is supported such that the sleeve housing base 2222 thereof is directed upward in a direction of gravity, facilitating a process of applying the primer 72 to the sleeve unit 22.

The annular grooves 61a and 61b arranged in the inner circumferential surface 61 of the holder portion 211 are also used as markers to apply the adhesive 71 to the holder portion 211 of the base bracket 21. In addition, the adhesive 71 held in the annular grooves 61a and 61b is adequately held between the sleeve unit 22 and the base bracket 21 upon inserting the sleeve unit 22 into the holder portion 211, enabling to firmly fix the sleeve unit 22 and the base bracket 21 to each other.

In the preferred embodiment of the present invention, since the adhesive 71 is the aerobic UV cure adhesive, the adhesive protruding from the axially lower end of the radially inner surface 51 of the sleeve housing 222 is easily cured.

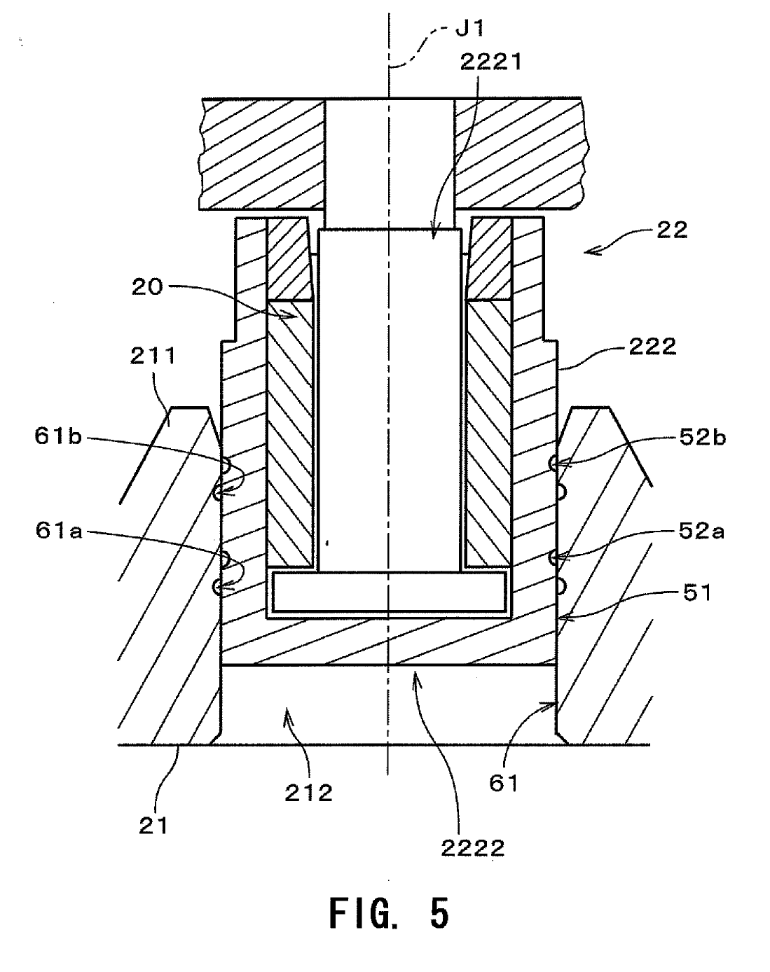

FIG. 5 is a cross sectional view illustrating a configuration of the bearing mechanism 20 of the motor 1 according to a second preferred embodiment of the present invention. Unlike the first preferred embodiment of the present invention, the bearing mechanism 20 adapted to a motor according to the second preferred embodiment of the present invention does not include the flange portion 52 arranged at the radially outer surface 51 of the sleeve unit 22. In the present preferred embodiment of the present invention, the motor includes the bearing mechanism 20 having annular concaves 52a and 52b arranged in the radially outer surface 51 of the sleeve housing 222 in a manner axially separated from each other. The rest of the configuration is substantially the same as the motor according to the first preferred embodiment of the present invention illustrated in FIG. 2.

In manufacturing of the motor according to the second preferred embodiment of the present invention, the primer is applied in the step S4 to an area of the radially outer surface 51 of the sleeve unit 22, the sleeve housing base 2222 side of the annular concave 52d when the rotor unit 3 and the sleeve unit 22 are supported as illustrated in FIG. 4. With the annular concave 52b arranged in the radially outer surface 51 of the sleeve unit 22, it is prevented that the primer applied to the area of the radially outside surface 51 flows along the radially outside surface 51 toward the opening 2221 (i.e., the annular concave 52 is used as the antisagging feature). In addition, by using the annular concave 52b as a mark, the primer 72 is adequately applied to the predetermined area. By adequately applying the primer, the sleeve unit 22 and the base bracket 21 are firmly fixed to each other with the primer 72 and the adhesive 71 while preventing the performance of the bearing mechanism from being degraded.

In the present preferred embodiment of the present invention, the adhesive 71 is held in the annular concaves 51a and 52b, similar to the adhesive held in the annular grooves 61a and 61b as described above, reinforcing the joint strength between the sleeve unit 22 and the base bracket 21.

In the first preferred embodiment of the present invention, the sleeve unit 22 includes the flange portion 52 arranged axially above the axially upper end of the holder portion 211 of the base bracket 21 as illustrated in FIG. 2. In the present preferred embodiment of the present invention, the annular concaves 52a and 52b are filled with the adhesive 71 to reinforce the joint strength between the sleeve unit 22 and the base bracket 21. In this point of view, the annular concaves 52a and 52b are preferably arranged in portions of the radially outer surface 51 radially facing to the inner circumferential surface 61 of the holder portion 211 when the sleeve unit 22 is inserted into the through hole 212 of the base bracket 21.

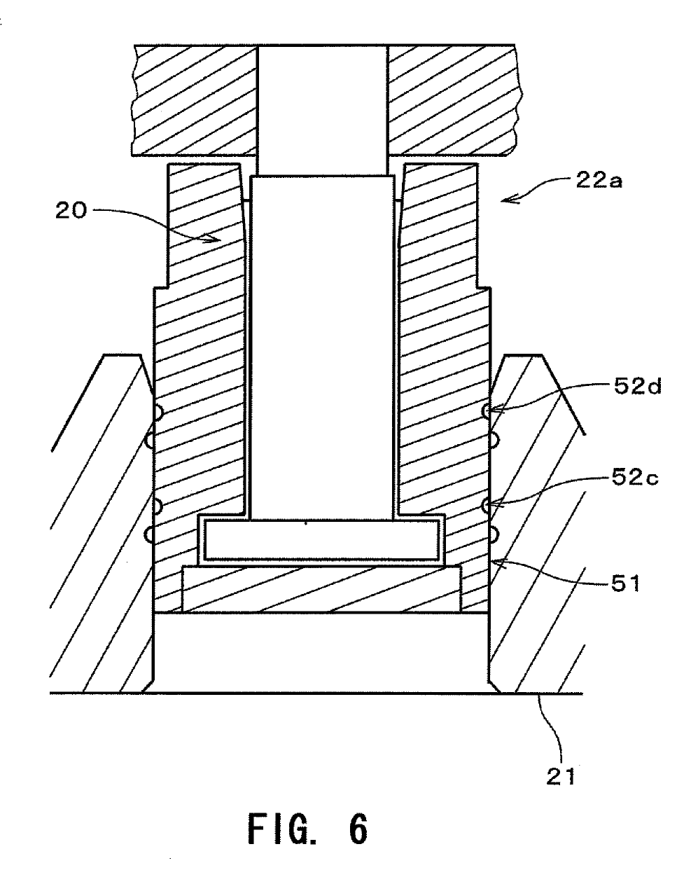

FIG. 6 is a cross sectional view illustrating a configuration of the bearing mechanism 20 of the motor 1 according to a third preferred embodiment of the present invention. Unlike the foregoing preferred embodiments of the present invention, the bearing mechanism 20 of the motor 1 according to the third preferred embodiment of the present invention does not includes the sleeve housing 222, and a radially outer surface of a sleeve 22a made of resin is directly fixed to the inner circumferential surface 61 of the holder portion 211. The sleeve unit 22a includes annular concaves 52c and 52d arranged in the radially outer surface 51 of the sleeve unit 22a in a manner axially separated from each other. The rest of the configuration of the bearing mechanism 20 of the motor 1 and the method of manufacturing the motor 1 are substantially the same as those described in the foregoing description of the first preferred embodiment of the present invention.

In the bearing mechanism 20 illustrated in FIG. 6, since the sleeve unit 22a is made of resin and has annular grooves 52b and 52c arranged in the radially outer surface 51 of the sleeve unit 22a, it is possible to adequately apply the primer to the predetermined area of the radially outer surface 51 of the sleeve unit 22a, enabling to firmly fix the sleeve unit 22a and the base bracket 21 to each other while preventing the bearing characteristic from being degraded.

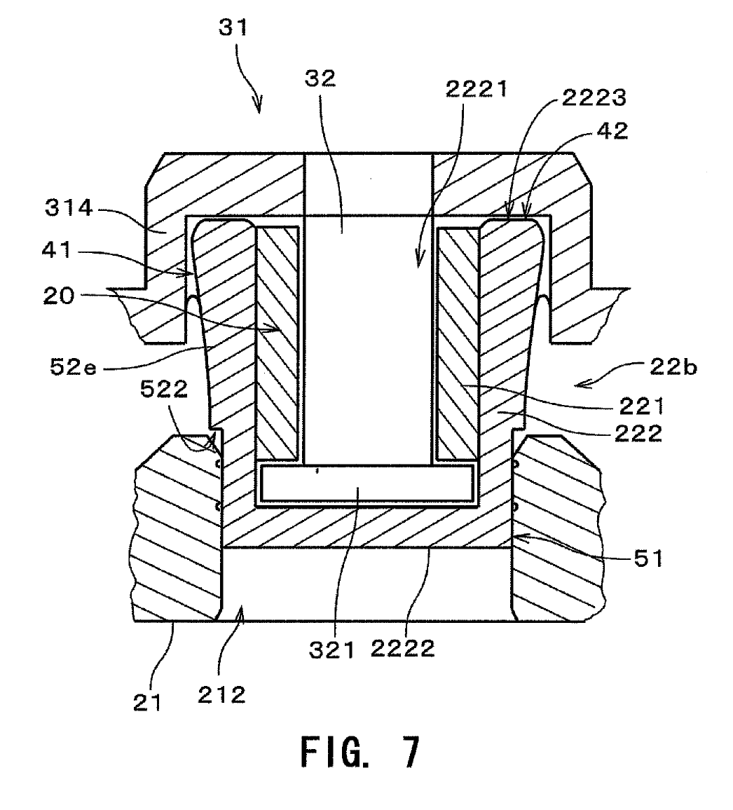

FIG. 7 is a cross sectional view illustrating a configuration of the bearing mechanism 20 of the motor 1 according to a forth preferred embodiment of the present invention.

As illustrated in FIG. 7, the motor 1 according to the fourth preferred embodiment of the present invention includes a sleeve housing 222 having a shape different from that described in the foregoing preferred embodiments of the present invention. Additionally, the sealing cap 223 is not provided to the motor according to the fourth preferred embodiment of the present invention. The sleeve housing 222 includes an upper section 52e at which an inclined face connecting to the outer-side face of the sleeve housing 222 is created. With the inclined face, the sleeve housing 222 gradually constricts in outer diameter heading the axially downward direction. A cylindrical section 314 of the rotor hub 31 is arranged radially outside of the upper section 52e of the sleeve housing 222 and is formed so that its inner-side surface, which radially opposes the radially outer surface of the sleeve housing 222 via a micro-gap defined therebetween, is of constant diameter. Thus, the micro-gap dimension in the radial direction grows gradually larger heading in the axially downward direction. The lubricating oil continuously fills the micro-gap between the sleeve housing 222 and the cylindrical portion 314 of the rotor hub 31, and other micro-gaps in the bearing mechanism 20 without interruption. Through the configuration, the boundary surface of the lubricating oil in the micro-gap between the sleeve housing 222 and the cylindrical portion 314 forms a meniscus under the agency of capillary action and surface tension, defining a taper seal section, whereby the gap functions as an oil buffer, preventing outflow of the lubricating oil.

The sleeve housing 222 includes a lower section having a diameter which is constant and is substantially the same as that of the sleeve housing base 2222. As illustrated in FIG. 7, an axially lower end of the upper section 52e has a greater diameter than the lower section of the sleeve housing 222, and the sleeve housing 222 includes a flaring portion 522 extending in the radial direction to connect the upper section 52e and the lower section of the sleeve housing 222. The lower section of the sleeve housing 222 (i.e., the a lower portion of the sleeve unit 22) is fitted into the holder portion 211 of the base bracket 21 and is fixed thereto with the adhesive 71 as previously described in the description of the foregoing preferred embodiments of the present invention.

In an axially upper surface 2223 of the sleeve housing 222, grooves (for example, grooves in spiral form) for developing in the lubricating oil pressure directed toward the center axis J1 when the rotor unit 3 spins are formed, wherein a thrust dynamic-pressure bearing section is defined with a gap 42 arranged axially between the axially upper surface 2223 and the axially lower surface of the rotor hub 31 opposing thereto. Other configuration of the bearing mechanism 20 of the motor 1 is substantially the same as that described in the description of the foregoing preferred embodiments of the present invention, in which the radial dynamic-pressure bearing section is defined between the shaft 32 and the sleeve 221 and the another thrust dynamic-pressure bearing section is defined between the thrust plate 321 and the sleeve housing 222.

The method of manufacturing the motor 1 illustrated in FIG. 7 is substantially the same as that described in the description of the foregoing preferred embodiments of the present invention. In the fourth preferred embodiment of the present invention, the flaring portion 522 is used as a marker to apply the primer to the lower section of the sleeve housing 222. With the flaring portion 522, the primer does not flow along the radially outer surface 51 of the sleeve housing 222 preventing the primer from reaching to the upper section 52e of the sleeve housing 222, defining a portion of the taper-seal section and the thrust dynamic-pressure bearing section. Through the configuration, the sleeve unit 22b and the base bracket 21 are firmly fixed to each other with the adhesive 71 while preventing the performance of the bearing mechanism 20 from being degraded.

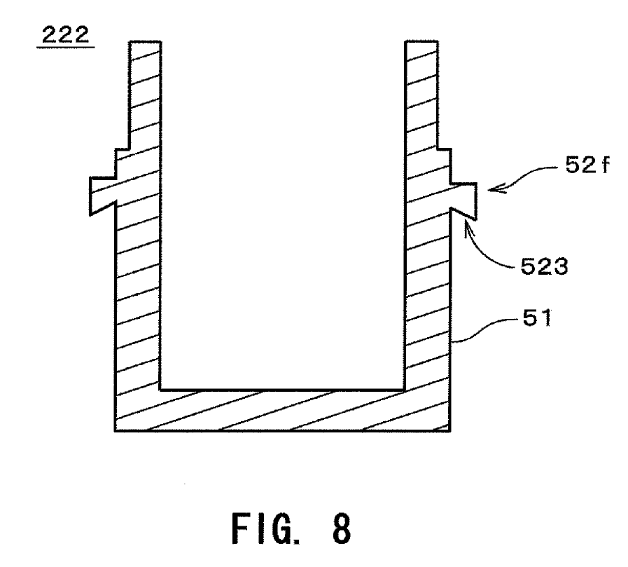

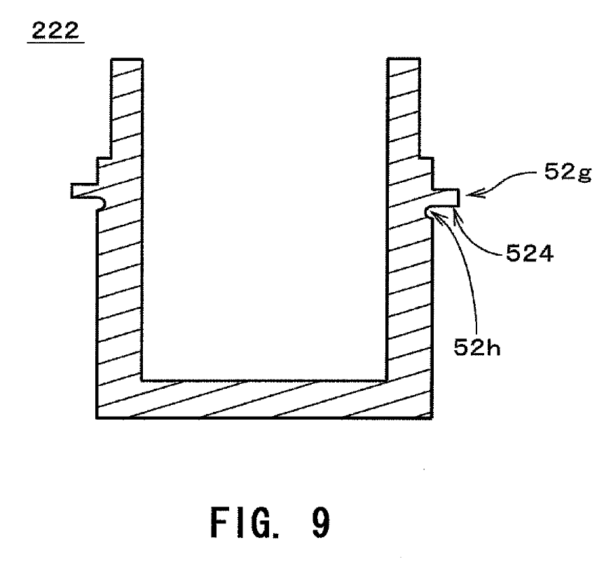

FIG. 8 is a view illustrating a cross section of the sleeve housing 222 of the motor 1 according to a fifth preferred embodiment of the present invention. FIG. 9 is a view illustrating a cross section of a sleeve housing 222 of the motor 1 according to a sixth preferred embodiment of the present invention.

In the foregoing preferred embodiments of the present invention, an axially lower surface 521 of the flange portion 52 illustrated in FIG. 2 or the flaring portion 522 illustrated in FIG. 7 are defined by an annular surface perpendicular to the center axis J1. In the fifth preferred embodiment of the present invention, an axially lower surface 523 of the flange portion 52f, restricting the flow of the primer in the axial direction along the radially outer surface 51 of the sleeve housing 222, makes an acute angle with the radially outer surface 51 of the sleeve housing 222 as illustrated in FIG. 8.

As illustrated in FIG. 9, the sleeve housing 222 may includes an annular concave portion 52h arranged immediately below a flange portion 52g to enlarge the annular surface 524 which prevents the primer from flowing along the radially outer surface 51 of the sleeve housing 222.

While shapes of the flange portion and the annular concaves have been described as being annular and the like, the shapes thereof are not limited to those detailed in the foregoing preferred embodiments, in that various modifications are possible. Meanwhile, additional concaves and convexes may be arranged in the radially outer surface 51 of the sleeve unit 22 to further reinforce the adhesive characteristics.

While embodiments of the present invention have been described in the foregoing, the present invention is not limited to the embodiments detailed above, in that various modifications are possible.

The flange portion and/or the concaves arranged in the radially outer surface of the sleeve housing may have any suitable forms as long as they prevent the axial flow of the primer along the radially outer surface. For example, the sleeve housing 222 may includes a plurality of small concaves arranged in the band shape extending over the entire circumference of the sleeve housing 222.

In the preferred embodiment of the present invention, the motor includes the base bracket supporting various components of the motor. It should be noted, however, the components of the motor may be supported on a base portion formed integral with a housing of the data storage disk drive.

The configuration of the hydrodynamic-pressure employing bearing mechanism is not limited to that described in the description of foregoing preferred embodiments of the present invention. Other types of hydrodynamic-pressure employing bearing mechanism may be adapted to the preferred embodiments of the present invention. Meanwhile, a bearing mechanism other than the hydrodynamic-pressure employing bearing mechanism (e.g., a slide bearing, ball bearing, and the like) may be adapted to the motor according to the preferred embodiments of the present invention.

It should be noted that the adhesive 71 may be other than the aerobic UV cure adhesive. The adhesive 71 may have one of a heat-curable property, an UV-curable property, an aerobic property, and combination thereof. For example, a heat curable adhesive, EPOTECH 353ND, commercially available from Epoxy Technology, may be used in the preferred embodiments of the present invention.

The area of the inner circumferential surface 61 to which the adhesive 71 is applied is not limited to that axially between the annular grooves 61a and 61b. For example, the adhesive 71 may be applied entire area of the inner circumferential surface 61.

The adhesive 71 may be applied to the radially outer surface 51 of the sleeve housing 222 to which the primer 72 is already applied. In other words, the adhesive 71 may be applied to at least one of the radially outer surface 51 of the sleeve unit 22 and the inner circumferential surface 61 of the base bracket 21 which radially opposes the radially outer surface 51 at least a point in a step of inserting the sleeve unit 22 into the base bracket 21. Alternatively, the primer and the adhesive may be applied to the same area on the radially outer surface 51 of the sleeve housing 222. Alternatively, the primer and the adhesive may be applied to the different areas on the radially outer surface 51 of the sleeve housing 222 as long as they are adequately spread when the sleeve unit 22 is inserted into the holder portion 211 of the base bracket 21. Meanwhile, the primer may be additionally applied to the inner circumferential surface 61 of the holder portion 211 of the base bracket 21 in order to reinforce the adhesive characteristics.

In the preferred embodiments of the present invention illustrated in FIGS. 2 and 7, the sleeve unit 22 is inserted into the through hole 212 of the base bracket 21 until the flange portion 52 and the upper section 52e of the sleeve housing 222 are about to come in contact with the holder portion 211. It should be noted, however, the flange portion 52 and the upper section 52e may be abutted against the holder portion 211 to position the sleeve unit 22 on the holder portion 211.

A motor according to the preferred embodiments of the present invention described above does not necessarily have to be the so-called outer rotor motor, in which the rotor magnet 33 is arranged radially outside of the armature 24, but may be an inner-rotor motor, in which the rotor magnet 33 is arranged radially inside of the armature 24. So-called air-pressure bearings, in which air serves as the working fluid, maybe adapted as the bearing mechanism 20 of the motor according to the preferred embodiments of the present invention.

A motor according to the preferred embodiments of the present invention may be used as the drive source for other devices apart from hard-disk drives-for example, disk-drive devices such as removable disk devices.

What is claimed is:

1. A method of manufacturing a motor including:
a shaft attached to a rotor unit;
a sleeve unit having a substantially cylindrical shape whose one end is opened and the other end is closed, in which the shaft is inserted from one end toward the other end; and
a base having a through hole defined by an inner circumferential surface, to which the sleeve unit is inserted,
the method comprising steps of:
a) applying a primer to a portion of a radially outer surface of the sleeve unit which includes an antisagging feature arranged over its substantially entire circumferential length, the portion of the radially outer surface is the other end side from the antisagging feature;
b) applying an adhesive to at least one of the portion of the radially outer surface of the sleeve unit and a portion of the inner circumferential surface of the base; and
c) inserting the other end side of the sleeve unit into the through hole defined by the inner circumferential surface of the base,
wherein the portion of inner circumferential surface of the base to which the adhesive is applied radially opposes the portion of the radially outer surface of the sleeve unit at least at a point in the step c).

2. The method of manufacturing the motor as set forth in claim 1, wherein the adhesive is anaerobic and an UV curable.

3. The method of manufacturing the motor as set forth in claim 1, wherein the sleeve unit constitutes a portion of a bearing mechanism employing a fluid dynamic pressure.

4. The method of manufacturing the motor as set forth in claim 3, wherein the sleeve unit includes a sleeve having a substantially cylindrical shape in which the shaft is inserted, and a sleeve housing made of resin and having a substantially cylindrical shape whose one end is opened and the other end is closed.

5. The method of manufacturing the motor as set forth in claim 1, wherein in the step a), the sleeve unit is supported in a manner that the other end of the sleeve unit is directed upward in a direction of gravity, and in the step c), the sleeve unit is inserted into the through hole of the base from the other end side of the sleeve unit.

6. The method of manufacturing the motor as set forth in claim 1, wherein the antisagging feature is a flange portion radially outwardly extending from the radially outer surface of the sleeve unit.

7. The method of manufacturing the motor as set forth in claim 1, wherein the antisagging feature is a concave portion at which the radially outer surface of the sleeve unit is radially inwardly indented.

8. An electrically powered motor comprising:
a sleeve unit having a substantially cylindrical shape whose one end is opened and the other end is closed, a radially outer surface of the sleeve unit is made of resin and includes an antisagging feature going around an entire circumference of the sleeve unit;
a rotor unit having a shaft inserted into the sleeve unit from one end to the other end and rotatably supported by the sleeve unit;
a base having a through hole defined by an inner circumferential surface to which the radially outer surface is attached by an adhesive arranged therebetween; and
a driving mechanism which generates rotation force rotating the rotor unit relative to the base.

9. The electrically powered motor as set forth in claim 8, wherein a primer is applied to the portion of a radially outer surface of the sleeve unit, and a portion of the radially outer surface is the other end side from the antisagging feature.

10. The electrically powered motor as set forth in claim 8, wherein the sleeve unit constitutes a portion of a bearing mechanism employing a fluid dynamic pressure.

11. The electrically powered motor as set forth in claim 10, wherein the sleeve unit includes a sleeve having a substantially cylindrical shape in which the shaft is inserted, and a sleeve housing made of resin and having a substantially cylindrical shape whose one end is opened and the other end is closed.

12. The electrically powered motor as set forth in claim 8, wherein the antisagging feature is a flange portion radially outwardly extending from the radially outer surface of the sleeve unit.

13. The electrically powered motor as set forth in claim 8, wherein the antisagging feature is a concave portion at which the radially outer surface of the sleeve unit is radially inwardly indented.
